(19) United States
(12) Patent Application Publication
(10) Pub. No.: US 2025/0109810 A1
(43) Pub. Date: Apr. 3, 2025

(54) SEALED CONNECTION ASSEMBLY

(71) Applicant: Junjie Huang, FUZHOU (CN)

(72) Inventor: Junjie Huang, FUZHOU (CN)

(21) Appl. No.: 18/375,556

(22) Filed: Oct. 2, 2023

(51) Int. Cl. F16L 15/08; F16L 15/00; F16L 15/04

(52) U.S. Cl. CPC F16L 15/08; F16L 15/008; F16L 15/04

(57) ABSTRACT

A sealed connection assembly includes: a coupling body, wherein the coupling body is cylindrical, an outer part of the coupling body is provided with an external thread, a nut, an inner side of the nut is provided with an internal thread, and the internal thread is adapted to the external thread; an upper end of the internal thread is further provided with an inwardly inclined inner slope; a sealing ring, wherein an inner wall of the sealing ring is further provided with a sealing groove, and the sealing groove is further provided with a flexible component. The above-mentioned technical solution can provide a physical structure for cooperating with a metal conduit for sealing, the sealing ring is compressed and extended by means of the internal threaded part of the nut, and the flexible component is protected by means of designing the sealing groove, thereby prolonging the service life of a connecting device.

### FIELD OF THE DISCLOSURE

The present application relates to the field of seal design and, in particular, to a waterproof duct assembly capable of better sealing.

### BACKGROUND OF THE INVENTION

In the prior art, metal conduits may be installed at two ends of a coupling for fixing, or the metal conduit may be installed at one end of a coupling and a base may be installed at the other end of the coupling for connecting.

In the existing coupling or connector, there is a structure in which a sealing material directly contacts a metal nut or locking ring, and there is a possibility that the sealing material is crushed when the nut or locking ring is rotatably assembled with a body, so that coupling or the connector loses the waterproof effect or does not achieve a satisfactory waterproof effect.

In other structures of the existing coupling or connectors, a metal washer is added between the other structural sealing material and the nut or locking ring to prevent a sealing ring from being crushed to be damaged by a locking ring, but this tends to cause the nut or locking ring to be thickened and a problem of an overhigh production cost of the metal washer.

### SUMMARY OF THE INVENTION

In view of the above-mentioned problems, the present application provides a new type of sealing coupling capable of making a structure of metal conduit sealing more stable.

To achieve the above object, the inventors provide a sealed connection assembly including: a coupling body, wherein the coupling body is cylindrical, an outer part of the coupling body is provided with an external thread, a nut, an inner side of the nut is provided with an internal thread, the internal thread is adapted to the external thread; an upper end of the internal thread is further provided with an inwardly inclined inner slope; a sealing ring, wherein an inner wall of the sealing ring is further provided with a sealing groove, and the sealing groove is further provided with a flexible component.

In an embodiment of the present application, a locking ring is further included, and the locking ring is provided with a locking ring clasp.

In one embodiment of the present application, the locking ring is arcuate in longitudinal section.

In one embodiment of the present application, an upper end surface of the locking ring conforms to and clamps a slope angle of the inner slope of the nut. In one embodiment of the present application, the flexible component is an elastomer. The elastomer is able to extend or expand a wider range to ensure weatherproof on coarse surface such as hot-dip galvanized rigid conduit and is adapt to larger tolerance of outer diameter of metal conduits.

In one embodiment of the present application, an outer sealing gasket and a locknut are further included, wherein the outer sealing gasket and a locknut are provided at a lower outer end of the coupling body, when a locknut is locked, an outer sealing gasket is compressed with the coupling body to achieve a sealing effect.

In one embodiment of the present application, a metal conduit is also included. An outer diameter of the metal conduit is slightly smaller than an inner diameter of the coupling body.

In one embodiment of the present application, a middle part of the coupling body is provided with an outward protrusion.

In one embodiment of the present application, the protrusions are hexagonal in cross-section.

Different from the prior art, the above-mentioned technical solution can provide a physical structure for cooperating with a metal conduit for sealing, the sealing ring is compressed by means of the internal threaded part of the nut, and the flexible component is protected by means of designing the sealing groove, thereby prolonging the service life of a connecting device.

The above-mentioned contents related to the invention are merely a summary of the technical solution of the present application, and in order to enable a person of ordinary skill in the art to more clearly understand the technical solution of the present application, the above-mentioned contents can be implemented according to the contents contained in the text of the description and the drawings, and in order to make the above-mentioned objects and other objects, features and advantages of the present application easier to be understood, the following description is given in conjunction with the particular embodiments of the present application and the drawings.

### BRIEF DESCRIPTION OF THE DRAWINGS

The drawings are only for purposes of illustrating the principles, implementations, applications, features and effects of particular embodiments and other related aspects of the present application and are not to be construed as limiting the present application.

In the drawings of the specification:

FIG. 1 is a longitudinal sectional view of a sealed connection assembly of an embodiment;

FIG. 2 is a longitudinal sectional view of a sealed connection assembly with a locking ring of the embodiment;

FIG. 3 is a schematic view showing a structure of the locking ring according to the embodiment; and

FIG. 4 is a structural diagram of a one-way connection assembly according to the embodiment.

### DESCRIPTION OF THE PREFERRED EMBODIMENTS

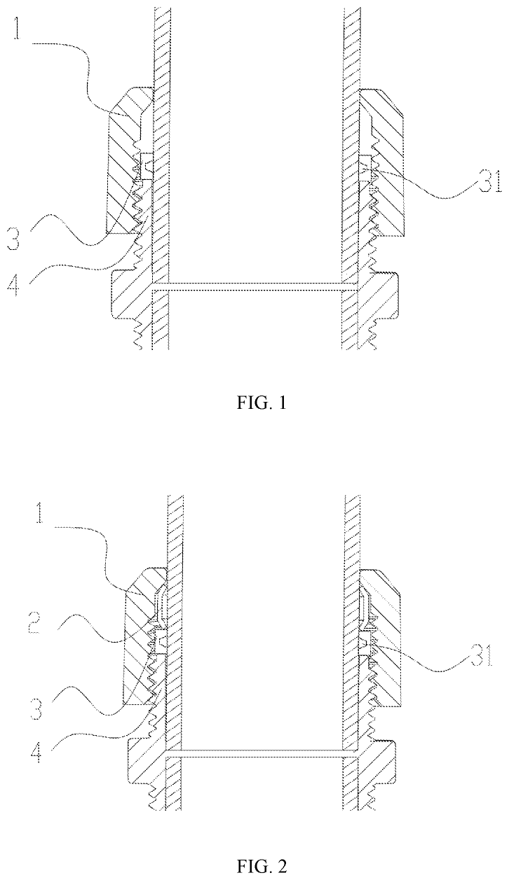

In some embodiments of the present application, as shown in FIG. 1, a sealed connection assembly includes: a nut 1, a coupling body 4, the coupling body 4 being cylindrical, and an outer part of the coupling body 4 being provided with an external thread. An inner side of the nut 1 is provided with an internal thread, and the internal thread is adapted to the external thread; an upper end of the internal thread is further provided with an inwardly inclined inner slope; a sealing ring 3, an inner diameter of the sealing ring 3 being equal to an inner diameter of the coupling body 4; an inner wall of the sealing ring 3 is further provided with a sealing groove 31, and a flexible component is further provided in the sealing groove 31. It can be seen from the figure that an upper half of the coupling body 4 is divided into a cylindrical tubular structure, an inner diameter of a lower end face of the nut 1 is equal to an outer diameter of the coupling body 4, so that the internal thread of the nut 1 is adapted to the external thread of the coupling body 4 and can be screwed onto each other, and an inner diameter of an upper end face of the nut 1 is equal to the inner diameter of the coupling body 4, so that a metal conduit of the inner ring can be closely adhered at the same time to achieve the sealing effect. In some embodiments, the sealing ring 3 may have an annular structure, wherein the sealing ring 3 is provided on the upper end face of the coupling body 4 and fitted to the coupling body 4, and the outer diameter of the sealing ring 3 is equal to the outer diameter of the coupling body 4, and the inner diameter of the sealing ring 3 is smaller than the inner diameter of the coupling body 4, and the sealing ring 3 can be wrapped by the nut 1 and the coupling body 4 in the above manner The flexible component may be a flexible material with a certain friction force, such as elastomer, rubber, plastic, silica gel, etc. After the nut 1 is screwed relatively to the coupling body 4, the inner slope of the nut 1 slightly causes the sealing ring 3 to deform, so as to press the sealing groove 31 and the flexible component in the sealing groove 31 to form a deformation and extension, so that the flexible component protrudes to seal inner metal conduits. At the same time as an internal threaded part of the nut 1 presses against the sealing ring 3, the nut 1 is always prevented from coming into contact with the flexible components, so that there is no problem of wearing the flexible components, thereby prolonging a life of a connecting device.

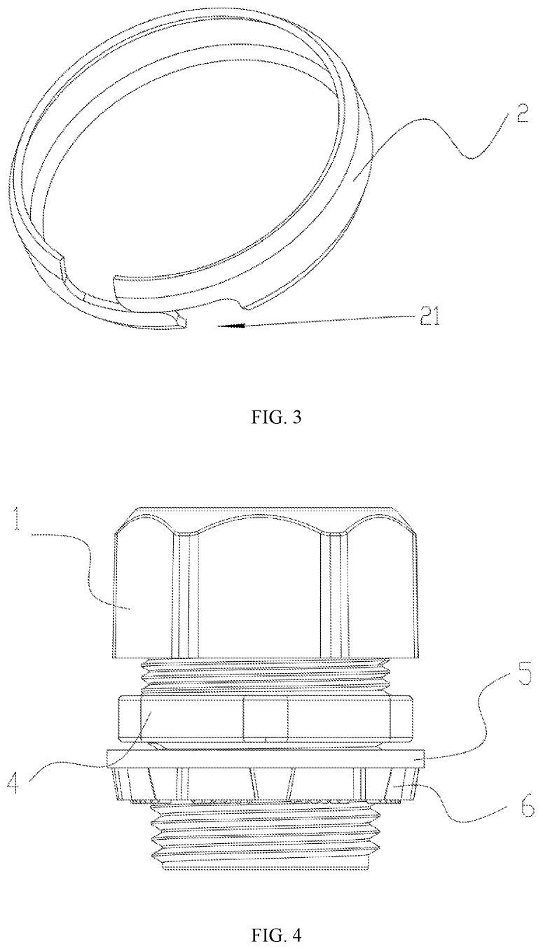

In an embodiment of the present application, and with continued reference to FIG. 2, a locking ring 2 is further included, wherein the locking ring 2 can be provided inside the nut 1 and is located at the upper end of the sealing ring 3 and the lower end of the inner slope of the nut 1. The locking ring 2 is provided with a locking ring clasp 21. In an embodiment illustrated in the embodiment shown in FIG. 3, the locking ring clasp 21 is a pre-set bayonet that is disconnected from a middle of the locking ring 2, and the opening of the bayonet may be arranged in a manner of being horizontally separated in a circumferential direction. The locking ring 2 can be selected as a metal piece, and the locking ring 2 can be adapted to a metal conduit within a pre-set thickness range by providing a locking ring clasp 21, so as to reduce accuracy requirements for manufacturing the locking ring 2 and better sleeving the metal conduits, and at the same time, the locking ring 2 can also lock the metal conduits after the nut 1 is screwed.

In a further embodiment as shown in FIG. 2, the locking ring 2 is arc shape in longitudinal section. The center of the circular arc is located inside the nut 1, and the advantage of the circular arc-shaped longitudinal section is that it enables the locking ring 2 to have an elasticity in the up-and-down direction, thereby providing elasticity for the sealing ring 3 when the nut 1 is screwed, also against the sealing ring 3.

In an embodiment of the present application, with reference to FIG. 2, the longitudinal section of the locking ring 2 is of a circular arc-shaped like design, and the outer side of the upper end face of the locking ring 2 conforms with and clamps the slope angle of the inner slope of the nut 1. The advantage of this design is that the locking ring 2 fits more tightly against the inner slope, provides a better water leakage prevention and a better lock with the metal conduits.

In some preferred embodiments, the flexible component is an elastomer. The elastomer only needs to be able to achieve the technical effect of deformation, and more specifically, a rubber ring also be provided, wherein the rubber ring has the features of low cost, strong friction, moderate deformation response and good sealing performance, and the technical effect of sealing and waterproofing can be better achieved by fixedly providing the rubber ring in the sealing ring 3. In a further preferred embodiment, the sealing groove 31 is adapted to the shape of the rubber ring and is integrally provided and fixed. This arrangement allows fewer components to be handled during the connecting operation, e.g. by clamping or gluing compounding the rubber ring in the sealing groove 31, which is more convenient for the user during use.

In some embodiments, the technical effect of two-end fixing can be achieved by connecting a lower part of the coupling body also with a nut, a sealing ring and a locking ring. An example of one-way butting with a metal conduit can also be seen next in FIG. 4, which in an embodiment as shown in FIG. 4 further includes an outer sealing gasket 5 and a locknut 6, the outer sealing gasket 5 and locknut 6 being provided at the lower outer end of the coupling body 4, the locknut 6 being able to compress the outer sealing gasket 5 with the coupling body 4 when locked to achieve a sealing effect. Specifically, in some embodiments, the metal conduit is connected to the upper end of the coupling body 4, one end of the head is inserted into the metal conduit, the other end of the coupling body 4 is an external thread feature with a through-hole in the middle, the external thread is sleeved with the external sealing gasket 5, and then installed in the base and locked by the locknut 6, and the locking of the locknut 6 causes the base and the body to compress the external sealing gasket 5, thereby providing a waterproof effect at the external thread end of the coupling.

In one embodiment of the present application, a metal conduit is also included. The outer diameter of the metal conduit is slightly smaller than the inner diameter of the coupling body 4. Better sealing can be achieved by providing a metal conduit according to the solution described above.

In order to allow the user to grasp the coupling body 4 while locking, preventing slippage, in some embodiments as shown in FIGS. 1 and 4, the central portion of the coupling body 4 is provided with an outward protrusion. Friction can be enhanced by the provision of protrusions.

Further, the cross-section of the projection may be hexagonal in order to provide better friction and facilitate screwing and the like by means of a wrench or the like. For example, the shape of the outer side of the cross-section of the protrusion is arranged as a hexagon.

In some general embodiments, a sealed connection assembly is provided that includes a one-piece seal ring having a plastic component at its periphery and a flexible rubber component at its center, with end-face contact and a slope therebetween. When the coupling or connector is used in the field or in engineering, the end face of the sealing assembly is subjected to compression deformation, and the slope enables the flexible component to be further compressed and extended toward the middle so as to be closely fitted with the metal conduit. The coupling assembly or the connector assembly are pre-assembled at the factory, namely, the body, the nut, the locking ring, the sealing ring, locknut, etc. are assembled at this time, wherein the body and the nut are pre-screwed by hand with 1-1.5 teeth, and the locking ring and the sealing ring are in an uncompressed shape. When a field worker uses a coupling or a connector, the metal conduit may be inserted directly into the body of the coupling or the connector from the nut opening in the pre-assembled coupling or the connector because the locking ring and the sealing ring are in an uncompressed state. The nut is then screwed by means of a tool, and during the screwing, the nut moves relative to the body; at this time, the inner slope of the nut will cause the locking ring to hold and fix the metal conduit; on the other hand, the inner slope of the nut will cause the locking ring to move towards the end surface of the body, thereby compressing the sealing ring assembly, and at the same time, the end surface of the plastic component of the sealing assembly is completely in contact with the end surface of the body and the flexible component in the sealing ring assembly is completely compressed and extended in contact with the metal conduit, so that the sealing assembly has a waterproof effect.

1. A sealed connection assembly comprising: a coupling body, wherein the coupling body is cylindrical, an outer part of the coupling body is provided with an external thread,
a nut, an inner side of the nut is provided with an internal thread, the internal thread is adapted to the external thread; an upper end of the internal thread is further provided with an inwardly inclined inner slope;
a sealing ring, wherein an inner wall of the sealing ring is further provided with a sealing groove, and the sealing groove is further provided with a flexible component.

2. The sealed connection assembly of claim 1, wherein the locking ring is further included, and the locking ring is provided with a locking ring clasp.

3. The sealed connection assembly of claim 2, wherein the locking ring is arcuate in longitudinal section.

4. The sealed connection assembly of claim 2, wherein an upper end surface of the locking ring conforms to and clamps a slope angle of the inner slope of the nut.

5. The sealed connection assembly of claim 1, wherein the flexible component is an elastomer.

6. The sealed connection assembly of claim 1, wherein an outer sealing gasket and a locknut are further included, wherein the outer sealing gasket and the locknut are provided at a lower outer end of the coupling body, when the locknut is locked, an outer sealing gasket is compressed with the coupling body to achieve a sealing effect.

7. The sealed connection assembly of claim 1, wherein a metal conduit is also included, and an outer diameter of the metal conduit is slightly smaller than an inner diameter of the coupling body.

8. The sealed connection assembly of claim 1, wherein a middle part of the coupling body is provided with an outward protrusion.

9. The sealed connection assembly of claim 8, wherein the protrusions are hexagonal in cross-section.
